(19) United States
(12) Patent Application Publication
(10) Pub. No.: US 2021/0184368 A1
(43) Pub. Date: Jun. 17, 2021

(54) Phased Array Antenna

(71) Applicant: AAC Technologies Pte. Ltd., Singapore city (SG)

(72) Inventors: Karen Goh, Singapore (SG); Guanhong Ng, Singapore (SG)

(21) Appl. No.: 17/012,091

(22) Filed: Sep. 4, 2020

(30) Foreign Application Priority Data
Dec. 13, 2019 (CN) 201911284510.5

(51) Int. Cl. H01Q 21/00; H01Q 21/22; H01Q 21/06

(52) U.S. Cl. CPC H01Q 21/0087; H01Q 21/0025; H01Q 21/065; H01Q 21/22

(57) ABSTRACT

An embodiment of the present invention provides a phased array antenna, including a PCB and a plurality of LTCC (low-temperature co-fired ceramic) patch antenna arranged on the PCB keeping a distance with each other; wherein each LTCC patch antenna is respectively installed on the PCB by surface mounting technology (SMT) and is electrically connected to a RF circuit on the PCB. The phased array antenna is designed and manufactured based on LTCC (low temperature co-fired ceramic) technology thereby providing a phased array antenna including a plurality of LTCC path antennas which avoids the uneven thermal expansion, and lowers the wrapping risk of the PCB.

### FIELD OF THE PRESENT DISCLOSURE

The invention relates to the field of wireless technologies, and in particular, to a phased array antenna.

### DESCRIPTION OF RELATED ART

In a related art, a phased array antenna is etched on a main PCB (printed circuit board). The phased array antenna is fixed inside the PCB, which results in that the PCB is too thick and not evenly layered and complicated design, besides, this design is not beneficial to the calibration of the phased array antenna and the radio frequency (RF) circuit verification. At the same time, the PCB board requires a more complex through-hole structure, which increases the cost to manufacture. In addition, during the operation, when a large amount of heat generated by the RF front-end component is transferred to the PCB, uneven layering may cause the PCB to warp due to uneven thermal expansion.

### SUMMARY OF THE PRESENT INVENTION

One of the objects of the present invention is to provide a phased array antenna designed and manufactured based on LTCC (low temperature co-fired ceramic) technology thereby providing a phased array antenna including a plurality of LTCC path antennas which avoids the uneven thermal expansion, and lowers the wrapping risk of the PCB.

To achieve the object mentioned above, the present invention provides a phased array antenna including:

a PCB and a plurality of LTCC (low-temperature co-fired ceramic) patch antenna arranged on the PCB keeping a distance with each other; wherein

each LTCC patch antenna is respectively installed on the PCB by surface mounting technology (SMT) and is electrically connected to a RF circuit on the PCB.

Further, the LTCC patch antenna comprises a LTCC substrate, an upper layer patch, a lower layer patch, and a feed part; the feed part is connected with the lower layer patch to provide feed, the upper layer patch is arrange at interval at a layer of the lower layer patch away from the feed part and is coupled to the lower layer patch, the upper layer patch is arranged on the surface of the LTCC substrate and is embedded in the LTCC substrate, the lower layer patch is arranged inside the LTCC substrate and corresponds to the projection position of the upper layer patch, the feed part passes through the LTCC substrate and is exposed outside the LTCC substrate to be electrically connected to the RF circuit.

Further, the phased array antenna operates in a millimeter wave band, and the distance between two adjacent LTCC patch antennas is 4-6 mm.

Further, the upper layer patch is in E-shape.

Further, a thickness of the LTCC substrate is 0.7 mm-0.8 mm.

Further, the RF circuit is printed on the PCB.

Further, the feed part is a coaxial feed structure.

Further, the phased array antenna adopts any one of a 2×2 array, a 4×4 array, or an 8×8 array.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an illustrative structural view of an 8×8 phased array antenna phased array antenna provided in embodiment 1 of the invention;

FIG. 2 is an illustrative structural view of a single LTCC patch antenna provided in embodiment 1 of the invention;

FIG. 3 is an illustrative cross-sectional view taken along line A-A in FIG. 2;

FIG. 4 is a schematic plan view of the 8×8 phased array antenna phased array antenna provided in embodiment 1 of the invention;

FIG. 5 is an illustrative cross-sectional view taken along line A-A in FIG. 1;

FIG. 6 is a return loss diagram of a single LTCC patch antenna provided in embodiment 1 of the invention;

FIG. 7 is a gain diagram of a single LTCC patch antenna provided in embodiment 1 of the invention;

FIG. 8 is an efficiency diagram of a single LTCC patch antenna provided in embodiment 1 of the invention;

FIG. 9 is a 3D gain direction diagram of a single LTCC patch antenna provided in embodiment 1 of the invention;

FIG. 10 is a 2D gain direction diagram within in the Phi=0° plane of a single LTCC patch antenna provided in embodiment 1 of the invention;

FIG. 11 is a 2D gain direction diagram within in the Phi=90° plane of a single LTCC patch antenna provided in embodiment 1 of the invention;

FIG. 12 is a 3D gain direction diagram of an 8×8 phased array antenna provided in embodiment 1 of the invention;

FIG. 13 is a gain curve diagram of an 8×8 phased array antenna provided in embodiment 1 of the invention;

FIG. 14 is a 2D gain direction diagram of the 8×8 phased array antenna in a Phi=0° plane provided in the embodiment 1 of the invention;

FIG. 15 is a 2D gain direction diagram of an 8×8 phased array antenna in a Phi=90° plane provided in the embodiment 1 of the invention;

FIG. 16 is a 2D gain direction diagram of an 8×8 phased array antenna of the embodiment 1 of the invention in a Phi=0° plane with different scanning angles.

### DETAILED DESCRIPTION OF THE EXEMPLARY EMBODIMENT

The present disclosure will hereinafter be described in detail with reference to an exemplary embodiments. To make the technical problems to be solved, technical solutions and beneficial effects of the present disclosure more apparent, the present disclosure is described in further detail together with the figure and the embodiments. It should be understood the specific embodiment described hereby is only to explain the disclosure, not intended to limit the disclosure.

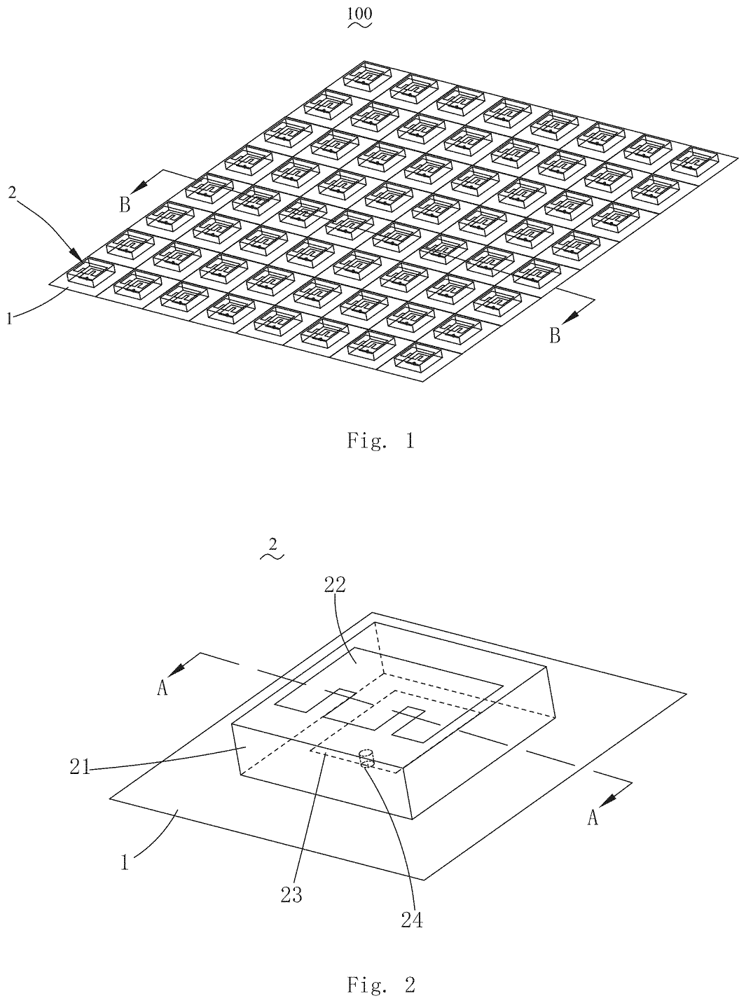

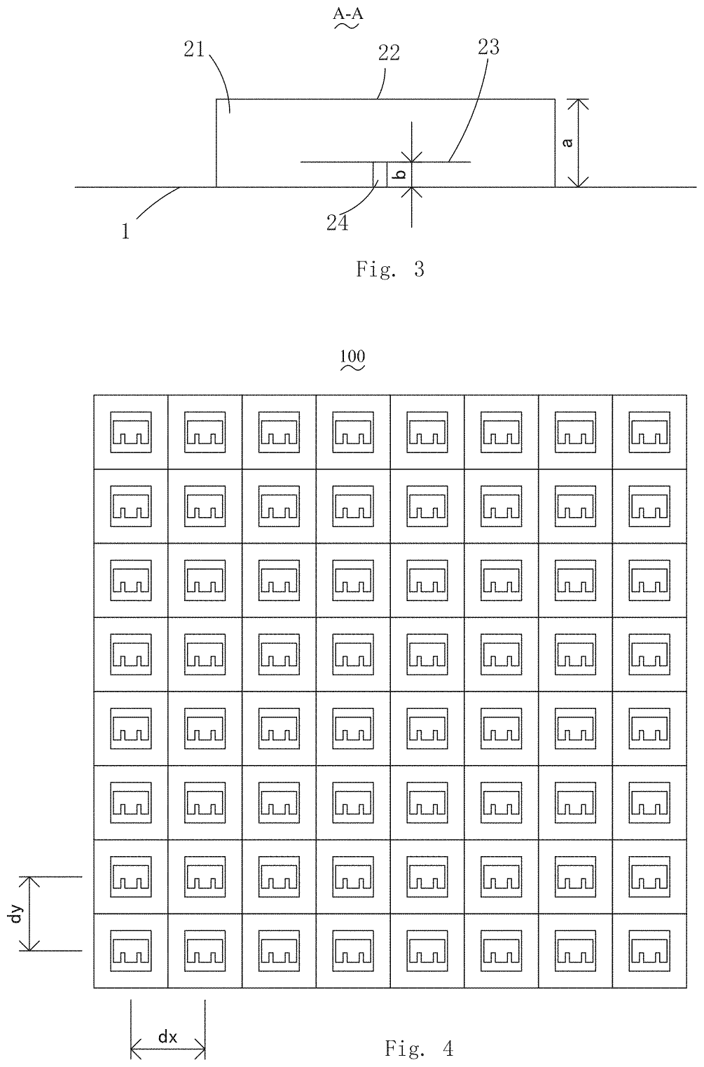

Please refer to FIG. 1, FIG. 2 and FIG. 3 together, the invention provides a phased array antenna 100 comprising a PCB 1 and a plurality of spaced LTCC patch antennas 2. Each of the LTCC patch antenna 2 is respectively installed on the PCB 1 by surface mounting technology (SMT), and is electrically connected to the RF circuit on the PCB 1. The LTCC patch antenna 2 comprises a plurality of LTCC substrates 21, an upper layer patch 22, a lower layer patch 23, and a feed part 24. The feed part 24 is connected to the lower layer patch 23 to provide power, and the upper layer patch 22 is arranged at interval at a layer of the lower layer patch 23 away from the feed part 24 and is coupled to the lower layer patch 23. The upper layer patch 22 is provided on the surface of the LTCC substrate 21 and embedded in the LTCC substrate 21. The lower layer patch 23 is provided inside the LTCC substrate 21 corresponding to the projection position of the upper layer patch 22. The feed part 24 passes through the LTCC substrate 21 and is exposed outside the LTCC substrate 21 to be electrically connected to the RF circuit.

The plurality of LTCC substrates 21 are independently arranged, and each of the plurality of LTCC substrate 21 corresponds to the LTCC patch antenna 2 one-to-one respectively. Specifically, in this embodiment, the LTCC substrate 21 is a DuPont 9kV7 board, the thickness a is 0.7798 mm, the upper layer patch 22 is in E-shape, and the distance between the upper layer patch 22 and PCB 1 is also a=0.7798 mm. The distance b between the lower layer patch 23 and PCB 1 is 0.2228 mm.

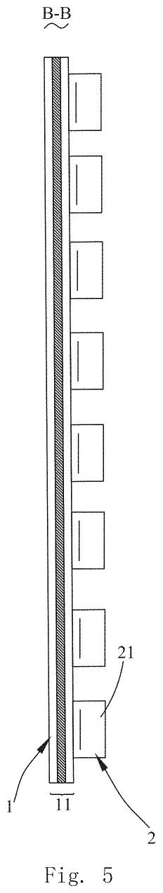

Please refer to FIG. 1 and FIG. 4 together, the phased array antenna works in the millimeter wave band, and the distance between two adjacent LTCC patch antennas is 4-6 mm. Specifically, in an 8×8 phased array antenna 100, the distance between adjacent LTCC patch antennas is dx=5.5 mm and dy=5.5 mm respectively.

Please refer to FIG. 1 and FIG. 5 together, each LTCC patch antenna 2 comprises a separate LTCC substrate 21, in particular, in this embodiment, the LTCC substrate 21 is installed on the PCB 1 through surface mounting technology (SMT) and electrically connected to the RF circuit 11 on the PCB 1. Therefore, each LTCC patch antenna 2 can be calibrated with a phased array antenna and radio frequency (RF) circuit verification before installation. At the same time, by setting the LTCC patch antennas 2 independently, the requirements for PCB 1 are reduced; no complicated through-hole design is required on PCB 1; meanwhile, since a single LTCC patch antenna 2 is independently separated, even if heat is transferred from the radio frequency (RF) front-end component to PCB 1, the warpage effect generated by PCB 1 is minimized.

Preferably, the phased array antenna utilizes any one of a 2×2 array, a 4×4 array, or an 8×8 array. The other phased array antenna is the same as the technical solution of this embodiment, and will not be described again.

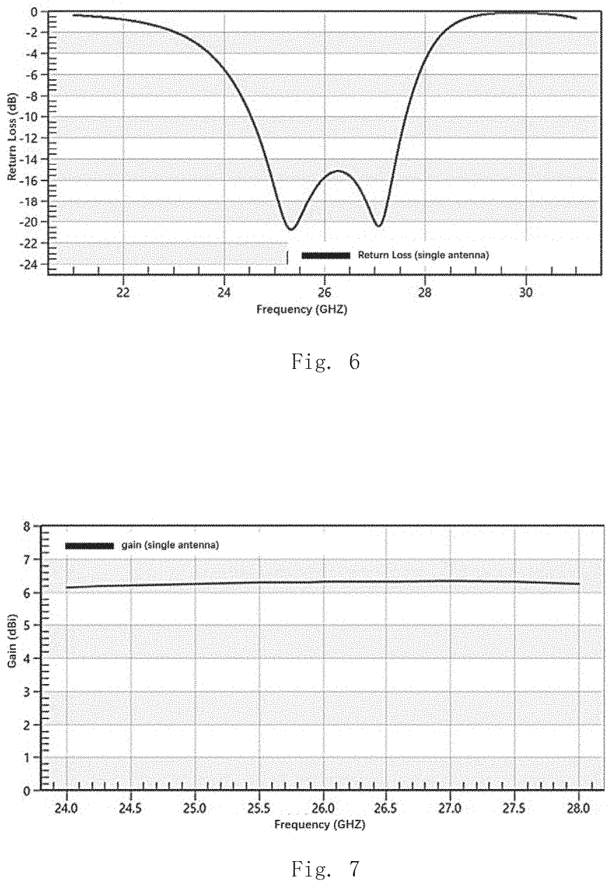

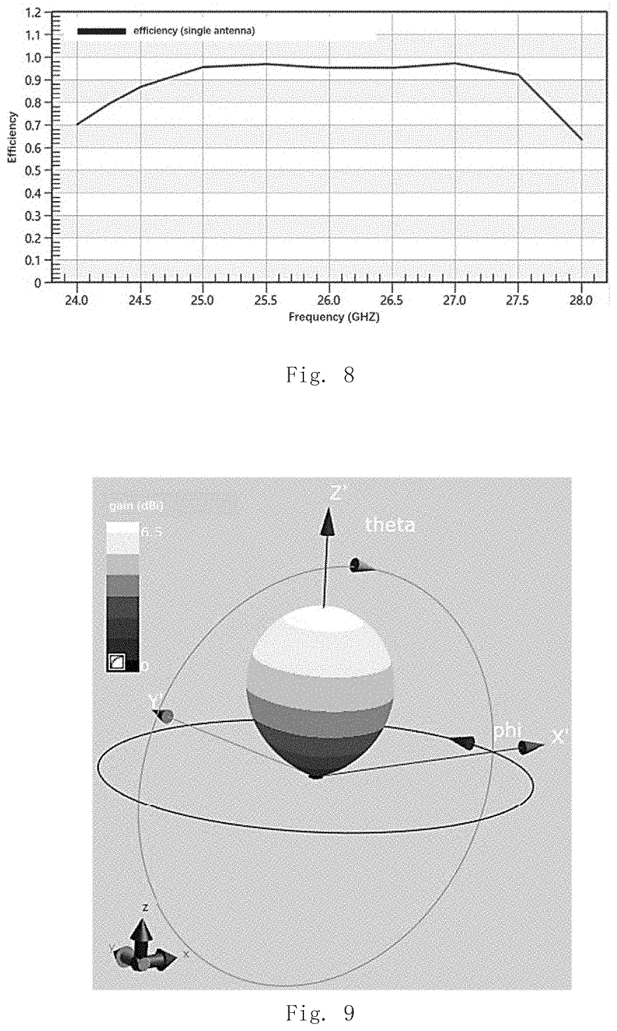

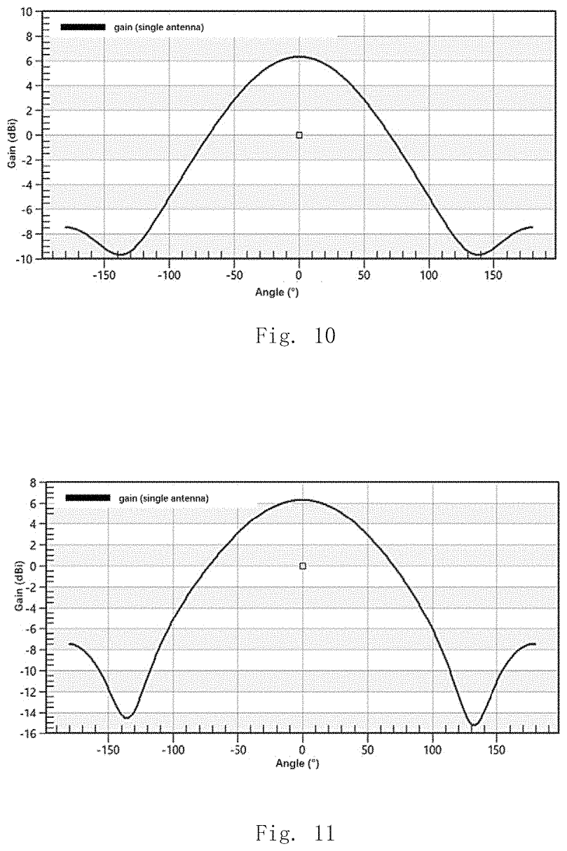

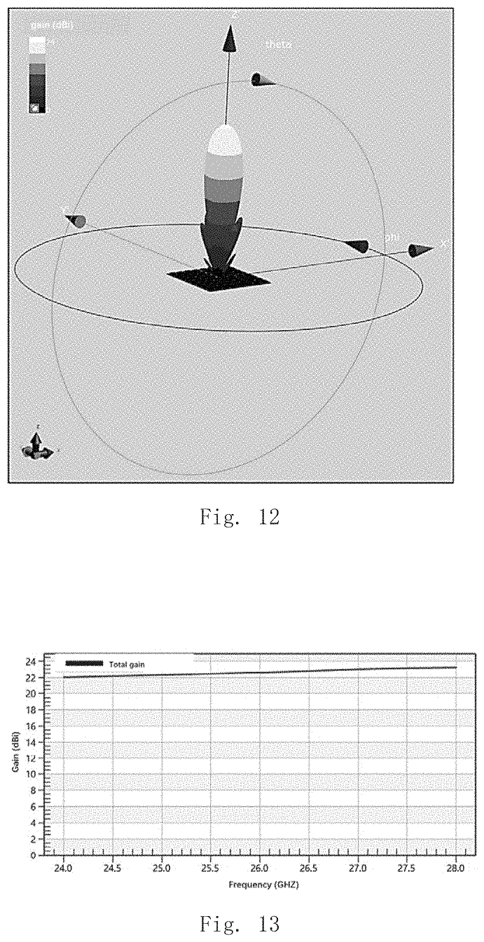

Please refer to FIG. 6-11, a single LTCC patch antenna has good performance at around 26 GHz.

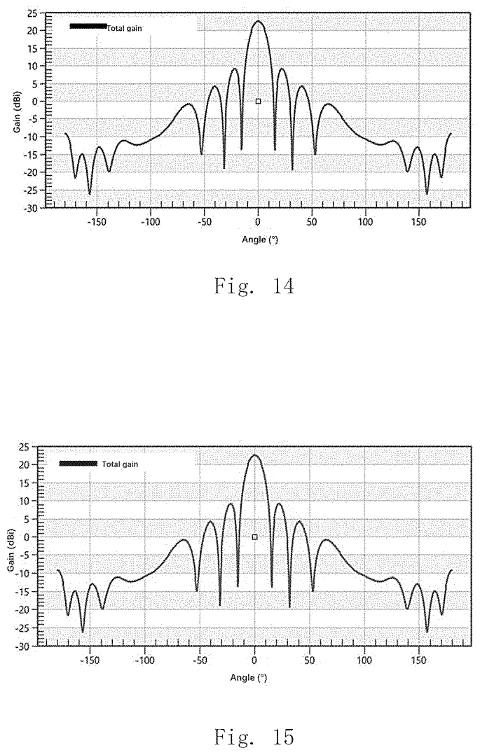

Please refer to FIG. 12-15, an 8×8 phased array antenna has good performance at around 26 GHz.

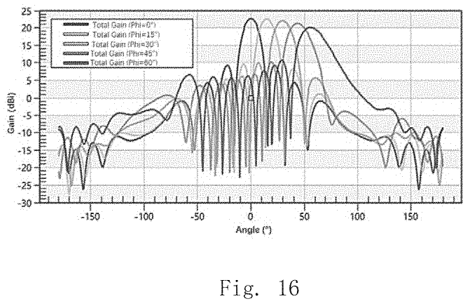

By setting the appropriate phase shift between each LTCC patch antenna, the 26 GHz 8×8 phased array antenna can be controlled to point in the desired direction. FIG. 16 is a 2D gain direction diagram (in the Phi=0° plane) of an 8×8 phased array antenna at 26 GHz when the scanning angle is 0°, 15°, 30°, 45°, and 60°. Similarly, the antenna beam can be steered through −15°, −30°, −45°, and −60°, while the 2D gain direction diagram (Phi=0° plane) is mirrored.

Compared with the prior art, the invention proposes a phased array antenna based on LTCC phased array antenna to separate the phased array antenna from the phased array antenna and set it independently, which simplifies the design requirements of the PCB and more cost-effective, avoids the uneven thermal expansion of the PCB caused by the heat transmitted by the RF front-end components, reduces the risk of PCB warpage; it is beneficial to detect and calibrate the RF circuit of the PCB.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A phased array antenna, comprising:
a PCB and a plurality of LTCC (low-temperature co-fired ceramic) patch antenna arranged on the PCB keeping a distance with each other; wherein
each LTCC patch antenna is respectively installed on the PCB by surface mounting technology (SMT) and is electrically connected to a RF circuit on the PCB.

2. The phased array antenna as described in claim 1, wherein the LTCC patch antenna comprises a LTCC substrate, an upper layer patch, a lower layer patch, and a feed part; the feed part is connected with the lower layer patch to provide feed, the upper layer patch is arrange at interval at a layer of the lower layer patch away from the feed part and is coupled to the lower layer patch, the upper layer patch is arranged on the surface of the LTCC substrate and is embedded in the LTCC substrate, the lower layer patch is arranged inside the LTCC substrate and corresponds to the projection position of the upper layer patch, the feed part passes through the LTCC substrate and is exposed outside the LTCC substrate to be electrically connected to the RF circuit.

3. The phased array antenna as described in claim 1, wherein the phased array antenna operates in a millimeter wave band, and the distance between two adjacent LTCC patch antennas is 4-6 mm.

4. The phased array antenna as described in claim 2, wherein the phased array antenna operates in a millimeter wave band, and the distance between two adjacent LTCC patch antennas is 4-6 mm.

5. The phased array antenna as described in claim 2, wherein the upper layer patch is in E-shape.

6. The phased antenna array as described in claim 2, wherein a thickness of the LTCC substrate is 0.7 mm-0.8 mm.

7. The phased antenna array as described in claim 2, wherein the RF circuit is printed on the PCB.

8. The phased array antenna as described in claim 2, wherein the feed part is a coaxial feed structure.

9. The phased array antenna as described in claim 1, wherein the phased array antenna adopts any one of a 2×2 array, a 4×4 array, or an 8×8 array.
